(19) United States
(12) Patent Application Publication
(10) Pub. No.: US 2007/0210992 A1
(43) Pub. Date: Sep. 13, 2007

(54) Electroluminescent wire display device

(76) Inventor: Gary M. Schein, Camarillo, CA (US)

Correspondence Address: LYON & HARR, LLP, 300 ESPLANADE DRIVE, SUITE 800, OXNARD, CA, 93036, US

(21) Appl. No.: 11/370,134

(22) Filed: Mar. 6, 2006

(51) Int. Cl. G09G 3/30

(52) U.S. Cl. 345/76

(57) ABSTRACT

A self-contained electroluminescent (EL) wire display device is presented for displaying different types of user-configurable information. Generally, the device includes a display module which contains an array of pegs located within a viewable window. Individual segments of EL wire are routed by a user through the array of pegs into a desired pattern. The edges of the display module are framed by hinged border strips. EL wire connectors are located along these edges underneath the border strips. A control module is included inside the display module which supplies an independent electrical signal to each connector. These signals cause the EL wires to emit light in a prescribed brightness and timing pattern according to the settings of various user controls located on the periphery of the display module. These controls allow the user to select from different display modes and adjust the overall sensitivity and brightness of the display module.

### BACKGROUND

Electroluminescent (EL) wire is a special type of wire which is commercially available off-the-shelf from a variety of suppliers. It is generally made up of a concentric series of layers, each of which performs a different function. The center layer consists of a copper core which is coated with an EL phosphor material. Fine-gauge wires, which are electrically connected together at one or more points, are then wrapped around this center layer, and then a translucent colored plastic coating and insulation coating are applied on top of the wrapped core. EL wire is “illumable” (i.e., it can be made to emit light). When an AC or DC electrical signal (hereafter simply referred to as an electrical signal) is applied between the copper core and the fine-gauge wires at the proper voltage (and frequency if an AC signal is involved), the phosphor material glows and hence, the EL wire emits light in the basic color of the plastic coating. Since different colored plastic coatings can be applied to the wire, different types of EL wire can be purchased which emit different colors of light. The brightness level of the light that is emitted is basically a function of the voltage level (and frequency if an AC signal is used) applied to the wire. In general, the higher the voltage (and frequency) applied to the wire, the greater the brightness of the light that is emitted. With some types of EL wire, the color of the light that is emitted can also be varied somewhat by varying the frequency if an AC signal is used.

A salient feature of EL wire is that it generally exhibits a small amount of latency between when the electrical signal is applied to the wire and when it starts to emit light, and also between when the electrical signal is removed from the wire and when it stops emitting light. Hence, EL wire is suitable for lighting applications where transient flashes of light or a strobe light effect are desired. Another salient feature of EL wire is that it is pliable. Hence, EL wire is suitable for a broad range of lighting applications where it is necessary for the light source to take on a certain shape or geometry. EL wire is also available in a range of different diameters (i.e., gauges), however, in general, the greater the diameter of the wire the lower its degree of pliability.

### SUMMARY

The present invention is directed toward a display device that utilizes electroluminescent (EL) wire for displaying user-configurable information. The display device generally includes an array of pegs to retain the EL wire in a variety of user-configurable geometric patterns. More particularly, the present invention is embodied in a display device that utilizes one or more individual segments of EL wire, each segment with potentially a different length and diameter and in potentially a different color, to display custom information generated by a user's shaping of the EL wire segments into a desired geometric pattern. The geometric pattern is generated by the user's routing of each EL wire segment (hereafter referred to as an EL wire) through an array of pegs located within a viewable window on the display device. The routed pattern of EL wires is maintained in place, in the event of display device movement, or impact or vibration to the display device, via novel peg designs which are described in detail below in the Detailed Description. The color, length, diameter and routing pattern of each EL wire are selected by the user based on the specific content of the information they want to display. The information displayed can easily be reconfigured either by the user's re-routing of existing EL wires through the array of pegs, or by their routing of new EL wires through the array of pegs. Each EL wire is plugged into a connector located in a series of one or more connectors that borders one or more edges on the periphery of the display device. The connectors are hidden underneath border strips which frame all the edges on the periphery of the display device. Each border strip is independently hinged in order to provide the user access to the underlying connectors.

Furthermore, the present display device is self-contained, portable and can be placed in any physical orientation. The display device can also be mounted for viewing in a variety of ways, including setting it either on its rear side or along one of its edges on a horizontal supporting surface such as an easel, shelf or table, or hanging it in a window, on a wall, or other vertical supporting surface, among others. The display device is electrically powered either by internal batteries or an external power supply. The EL wires are “illumable” (i.e., they can be made to emit light). A control module is included inside the display device which supplies an independently controlled electrical signal to each of the aforementioned connectors. Each connector in turn supplies its electrical signal to the EL wire that may be plugged into the connector, which causes the wire to emit light in a color corresponding to the specific wire. The control module independently controls the brightness and timing pattern of the light emitted by each EL wire plugged in by independently controlling the characteristics of each electrical signal supplied to each connector. The user can select from a variety of display modes, and adjust the overall display sensitivity and brightness, via user controls located on the periphery of the display device. By way of example but not limitation, in one particular display mode the EL wires emit light continuously at a prescribed level of brightness. In another particular display mode the EL wires emit transient flashes of light in synchronization with changes in the frequency and/or amplitude of an external signal supplied to the display device from a microphone. In yet another particular display mode the EL wires emit transient flashes of light in synchronization to changes in the frequency and/or amplitude (i.e., the “beat”) of an external signal supplied to the display device from an audio source. The display device also includes additional display modes which are described in the Detailed Description below.

The present display device can be used to create and display a variety of types of information. The display device can also be used for a variety of purposes in a wide range of different markets and applications such as the novelty, toy, recreation, art and commercial signage markets, among others.

It should be noted that this Summary is provided to introduce a selection of concepts, in a simplified form, that are further described below in the Detailed Description. This Summary is not intended to identify key features or essential features of the claimed subject matter, nor is it intended to be used as an aid in determining the scope of the claimed subject matter. In addition to the just described benefits, other advantages of the present invention will become apparent from the detailed description which follows hereinafter when taken in conjunction with the drawing figures which accompany it.

### DESCRIPTION OF THE DRAWINGS

The specific features, aspects, and advantages of the present invention will become better understood with regard to the following description, appended claims, and accompanying drawings where:

FIG. 1 shows an exemplary front view of a display module associated with a display device according to the present invention.

FIG. 2 shows an exemplary cross-section view of one peg on the display module of FIG. 1.

FIG. 3 shows an exemplary rear view of the display module of FIG. 1.

FIG. 4 shows an exemplary diagram depicting electronics and related electrical components included inside the display module of FIG. 1.

FIG. 5 shows an exemplary front view of one embodiment of an array of pegs on the display module of FIG. 1 in which the array is made up of a number of strips of pegs joined together.

FIG. 6 shows an exemplary cross-section view of a one embodiment of one of the strips of pegs of FIG. 5.

FIG. 7 shows an exemplary cross-section view of three of the strips of pegs of FIG. 5 joined together in self-aligning, interlocking fashion.

FIG. 8 shows an exemplary front view of another embodiment of the array of pegs on the display module of FIG. 1 in which the array is made up of a number of holes constructed into a plate.

FIG. 9A shows an exemplary cross-section view of one embodiment of a peg constructed as a stand-alone part.

FIG. 9B shows an exemplary cross-section view of another embodiment of a peg constructed as a stand-alone part

FIG. 10 shows an exemplary cross-section view of another embodiment of one of the strips of pegs of FIG. 5.

FIG. 11 shows an exemplary cross-section view of yet another embodiment of one of the strips of pegs of FIG. 5, into which the peg of FIG. 9 is plugged.

### DETAILED DESCRIPTION

In the following description of embodiments of the present invention reference is made to the accompanying drawings which form a part hereof, and in which are shown, by way of illustration, specific embodiments in which the invention may be practiced. It is understood that other embodiments may be utilized and structural changes may be made without departing from the scope of the present invention.

In general, the present invention relates to a display device that utilizes electroluminescent (EL) wire for displaying user-configurable information. The display device includes an array of pegs to retain the EL wire in a variety of user-configurable geometric patterns. More particularly, the present invention is embodied in a display device that utilizes one or more individual segments of EL wire, each segment with potentially a different length and diameter and in potentially a different color, to display custom information generated by a user's shaping of the EL wire segments into a desired geometric pattern. In general, the geometric pattern is generated by the user's routing of each EL wire segment (hereafter referred to as an EL wire) through an array of pegs located in a viewable window on the display device. The routed pattern of EL wires is maintained in place, in the event of display device movement, or impact or vibration to the display device, via novel peg designs which are described in detail below. The display device is self-contained, portable, can be placed in any physical orientation, and can be mounted for viewing in a variety of ways which are described in detail below. The EL wires in the display device are “illumable” (i.e., they can be made to emit light). The brightness and timing pattern characteristics of the light emitted by each EL wire are controlled by a control module included inside the display device, in combination with a variety of user controls which are located on the periphery of the display device. The control module also serves to operate the display device in a variety of display modes, each of which is described in detail below.

The present display device can be used to create and display a variety of types of information including but not limited to letters, numbers, symbols, shapes and characters in any size, combination and physical orientation. The display device can also be used for a variety of purposes in a wide range of different markets and applications such as the novelty, toy, recreation, art and commercial signage markets, among others.

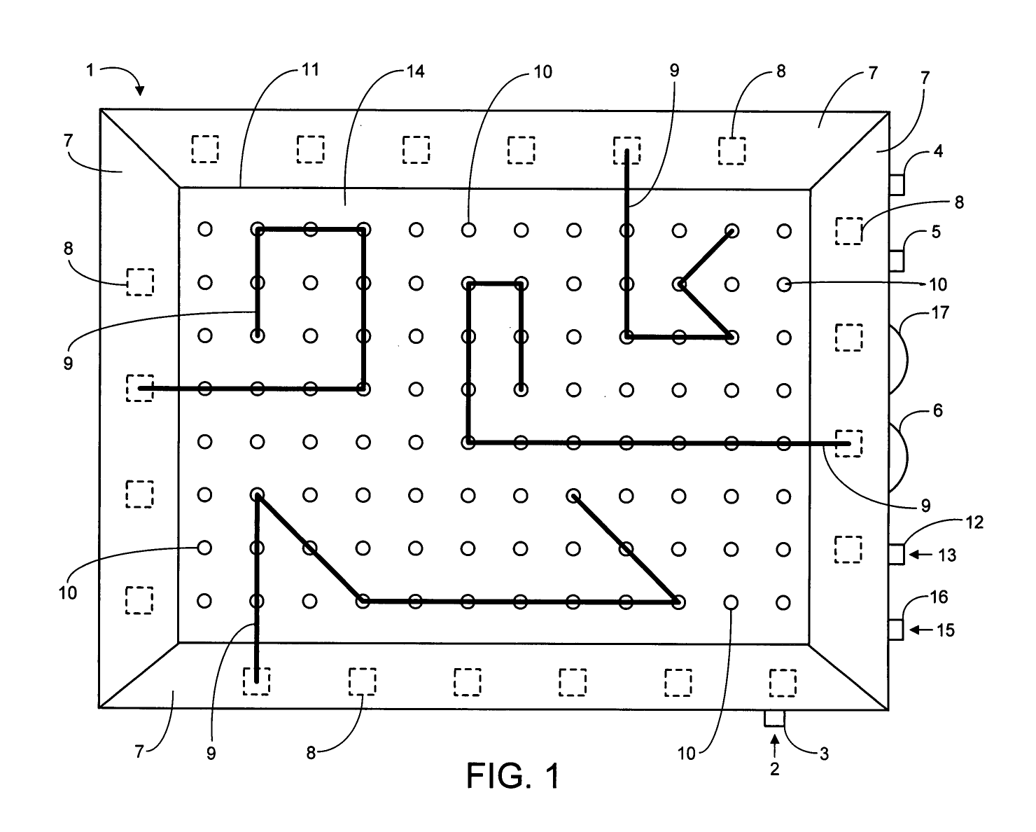

FIG. 1 shows an exemplary front view of one embodiment of the present display device. The display device includes a self-contained display module 1 which is electrically powered either by batteries (not shown) installed into a battery compartment (not shown) located inside the display module 1, or by an external power signal 2 which is supplied by a conventional power adapter module (not shown) located external to the display module 1. The external power signal 2 connects to the display module 1 via an electrical cable (hereafter referred to as a cable—not shown) that plugs into a power connector 3 located on the periphery of the display module 1. One or more EL wire connectors 8 border one or more of the edges on the periphery of the display module 1. One or more EL wires 9, each including a resilient connector (not shown) on one end which is designed to mate with the connector 8 and retain the EL wire 9 in the connector 8, can be plugged into the EL wire connectors 8 and routed through an array 14 of pegs 10 located within a viewable window 11 on the front of the display module 1. The color, length, diameter and geometric routing pattern of each EL wire 9 can be independently selected and varied by the user based on the specific content of the information they want to portray on the display device. The maximum allowable EL wire diameter is dictated by the spacing between the pegs 10 in the array 14.

Referring again to FIG. 1, all the edges on the periphery of the display module 1 are framed by border strips 7 which serve to hide and protect the EL wire connectors 8 which may lie underneath, and also to improve the visual appearance of the display device. Each border strip 7 is independently hinged onto the display module 1 by one or more hinges (hinges are not shown) located along the coincident peripheral edges of the border strip 7 and the display module 1. The user can lift the inside edge of the border strip 7, hence rotating it up along its hinge(s) away from the array 14 of pegs 10, in order to gain access to the underlying EL wire connectors 8. After lifting a border strip 7, an EL wire 9 is plugged by the user into one of the exposed EL wire connectors 8 and from there the EL wire 9 is routed by the user through the array 14 of pegs 10 to create their desired geometric pattern. This process is continued for each individual EL wire 9 until the user has completed all of the EL wire 9 selections and routing needed to create the information content they want to portray on the display device. The information displayed can easily be reconfigured either by the user's re-routing of existing EL wires 9 through the array 14 of pegs 10, which may include moving existing EL wires 9 to new, unused EL wire connectors 8 either located underneath the same border strip 7 or a different border strip 7, and/or by the user's plugging additional new EL wires 9 into the EL wire connectors 8 and routing the new EL wires 9 through the array 14 of pegs 10.

Referring yet again to FIG. 1, a control module (not shown) is included inside the display module 1 which serves, in conjunction with a variety of user controls located on the periphery of the display module 1, to control all of the electrical features and display mode features of the display device. These user controls, electrical features and display mode features will now be described in detail. The control module supplies an independently controlled electrical signal to each EL wire connector 8, which in turn supplies the electrical signal to an EL wire 9 which may be plugged into the connector 8. The electrical signal causes the EL wire 9 to emit light in a color corresponding to the specific characteristics of that particular wire 9. The control module independently controls the brightness level and timing pattern of the light emitted by each EL wire 9 plugged into the display module 1 by independently controlling the voltage level (and frequency if an AC signal is used) of the electrical signal supplied to each connector 8, and independently turning the electrical signals on and off. The user can turn the overall display module 1 on and off via a display mode switch 5 located on the periphery of the display module 1. As discussed in detail below, the display mode switch 5 is also used to select a particular operating display mode for the display module 1. A test button 4 is also located on the periphery of the display module 1. Assuming the display mode switch 5 is in a position other than the off position, when the user depresses the test button 4 the display mode that the display module 1 is currently operating in is temporarily overridden and all the EL wires 9 continuously emit light until the user releases the test button 4, after which the display module 1 returns to operating in the display mode set by the display mode switch 5. This on-demand temporary test mode is useful to allow the user to quickly preview their information on the display module 1.

Referring yet again to FIG. 1, the user can select from a variety of display modes via a display mode switch 5 also located on the periphery of the display module 1. By way of example but not limitation, in one particular display mode all the EL wires 9 plugged into the display module 1 emit light continuously at a prescribed brightness level (referred to hereafter as the “constant-on” display mode). In another display mode all the EL wires 9 flash on and off in unison at a prescribed duty cycle (referred to hereafter as the “constant-flash” display mode). In yet another display mode each EL wire 9 flashes on and off randomly (referred to hereafter as the “random-flash” display mode). In yet another display mode, the EL wires 9 flash on and off in synchronization with changes in the frequency and/or amplitude of a microphone signal 13 which is supplied to the display module 1 by a conventional microphone (not shown) located external to the display module 1 (referred to hereafter as the “microphone-sync” display mode). The microphone signal 13 connects to the display module 1 via a cable (not shown) that plugs into a microphone connector 12 located on the periphery of the display module 1. In yet another display mode, the EL wires 9 flash on and off in synchronization to changes in the frequency and/or amplitude (i.e., the “beat”) of an auxiliary audio signal 15 which is supplied to the display module 1 by one of a variety of possible audio sources (such as a CD player, MP3 player or radio, among others—not shown) located external to the display module 1 (referred to hereafter as the “audio-sync” display mode). The auxiliary audio signal 15 connects to the display module 1 via a cable (not shown) that plugs into an auxiliary audio connector 16 located on the periphery of the display module 1. A sensitivity control dial 6 is located on the periphery of the display module 1, which can be used by the user to adjust the sensitivity of the control module (not shown) in particular display modes. By way of example but not limitation, in the constant-flash display mode the sensitivity control dial 6 can be used to adjust the rate at which the EL wires 9 flash. In either the microphone-sync or audio-sync display modes the sensitivity control dial 6 can be used to adjust the sensitivity of the control module (not shown) to either the microphone signal 13 or the auxiliary audio signal 15.

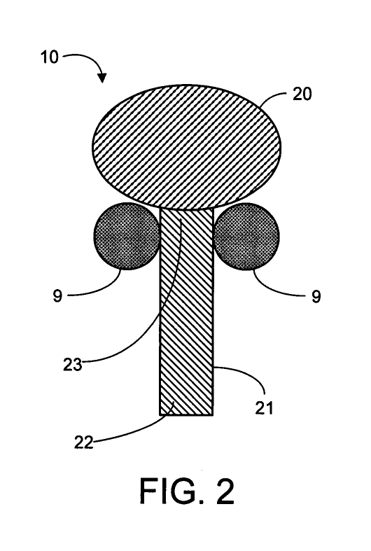

FIG. 2 shows an exemplary cross-section view of one embodiment of one of the pegs 10 on the display module 1 of the present display device along with two EL wires 9 which are routed along either side of the peg 10. Each peg 10 includes two sections, a post 21 and a cap 20. In one embodiment, the post 21 is cylindrically shaped and serves to channel the routing of the EL wires 9. The proximal end 22 of each post 21 attaches to the array 14. The cap 20 attaches to the distal end 23 of each post 21. In one embodiment, the cap 20 is cylindrically shaped with a domed top and bottom surface. The cap 20 has a circumference that is larger than the circumference of the post 21 in order to retain the EL wires 9 routed adjacent to the post 21 in place under the cap 20. This inhibits the EL wires 9 from slipping over the peg 10, hence maintaining the user's EL wire routing patterns, in the event that the display module 1 is subjected to movement, impact or vibration. As discussed in more detail below, the post 21 and cap 20 can either be constructed together as a single part, or alternatively, the cap 20 can be constructed as a separate part which is plugged onto the post 21 by the user.

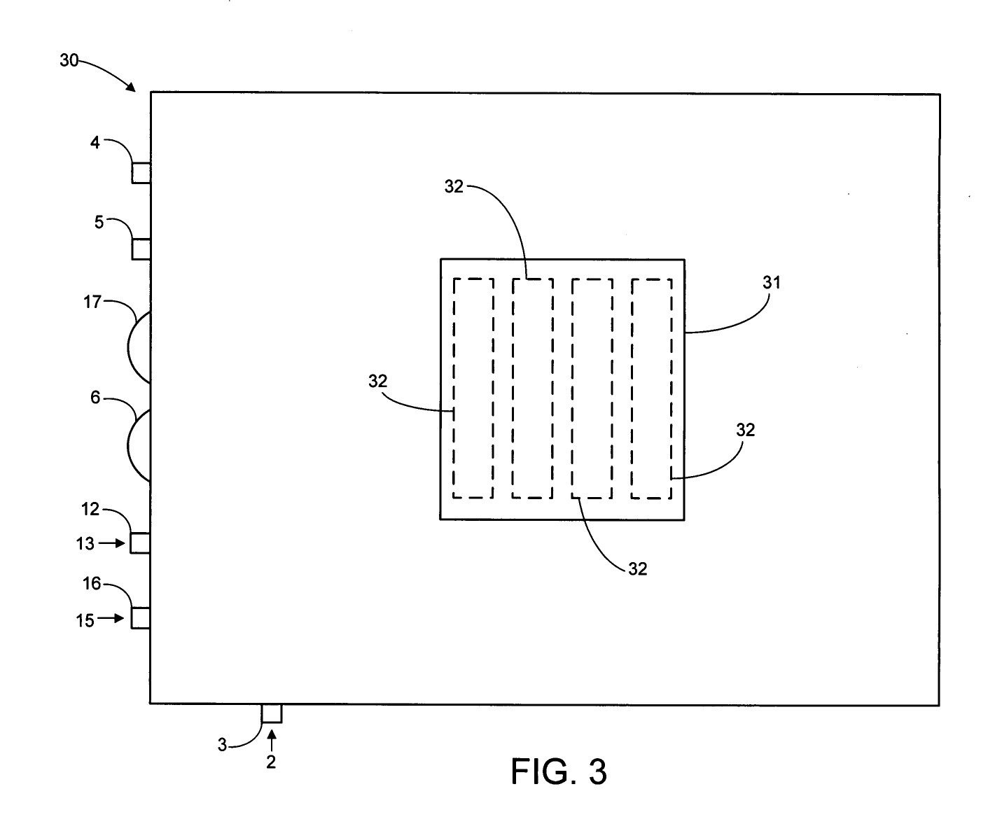

FIG. 3 shows an exemplary rear view 30 of one embodiment of the display module 1 of the present display device. The rear side of the display module 30 is solid in construction serving to provide a rigid structure on which the rest of the display module 1 is built, and also to enclose and protect the contents located inside the display module 1. The rear side of the display module 30 also provides access to a battery compartment 31, which is normally shielded by a removable cover (detail of which is not shown) which serves to protect the batteries 32 and retain them in place in their respective holders (detail of which are not shown). By removing the cover the user can gain access to the battery compartment 31 in order to remove existing batteries 32 and/or install new batteries 32 as needed.

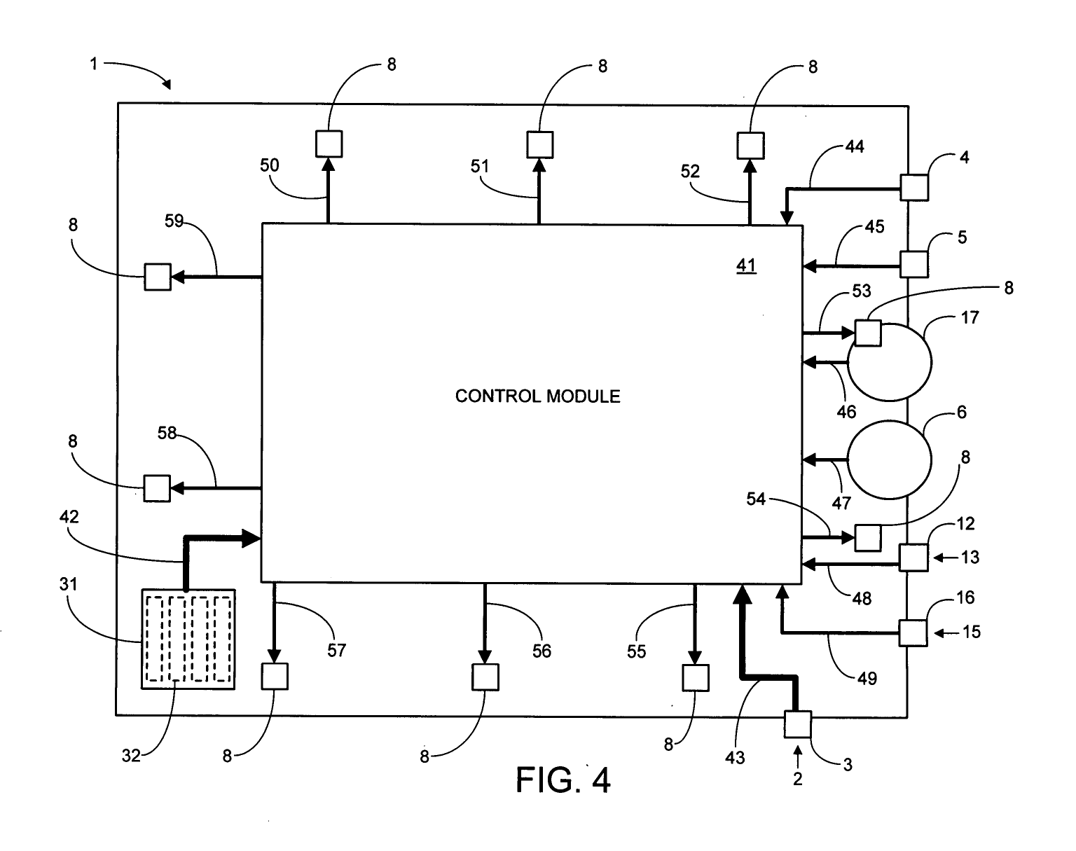

FIG. 4 shows an exemplary diagram of the electronics included inside the display module 1 of the present display device along with the interconnection of these electronics to the user controls and connectors located on the periphery of the display module 1. It should be noted that this diagram is intended only to show the most basic architecture of the electronics and their interconnection to the user controls and connectors. The batteries 32 located inside the battery compartment 31 are connected to the control module 41 via cable 42. The external power signal 2, which is input into connector 3, is connected to the control module 41 via cable 43. The test button 4 is connected to the control module 41 via cable 44. The display mode switch 5 is connected to the control module 41 via cable 45. The sensitivity control dial 6 is connected to the control module 41 via cable 47. The microphone signal 13, which is input into connector 12, is connected to the control module 41 via cable 48. The auxiliary audio signal 15, which is input into connector 16, is connected to the control module 41 via cable 49. Operating from the power supplied via cables 42 and 43, the microphone and auxiliary audio signals 13 and 15 supplied via cables 48 and 49, and the control signals (not shown) provided from the various user controls 4, 5, 17 and 6 via cables 44, 45, 46 and 47, the control module 41 generates an independent EL wire electrical signal (not shown) and supplies it to each of the EL wire connectors 8 via cables 50-59. It should be noted that fewer EL wire connectors 8 are depicted in FIG. 4 than in FIG. 1 in order to improve the clarity of FIG. 4. As discussed below, different embodiments of the present display device are possible in which the quantity and locations of the EL wire connectors 8 is varied.

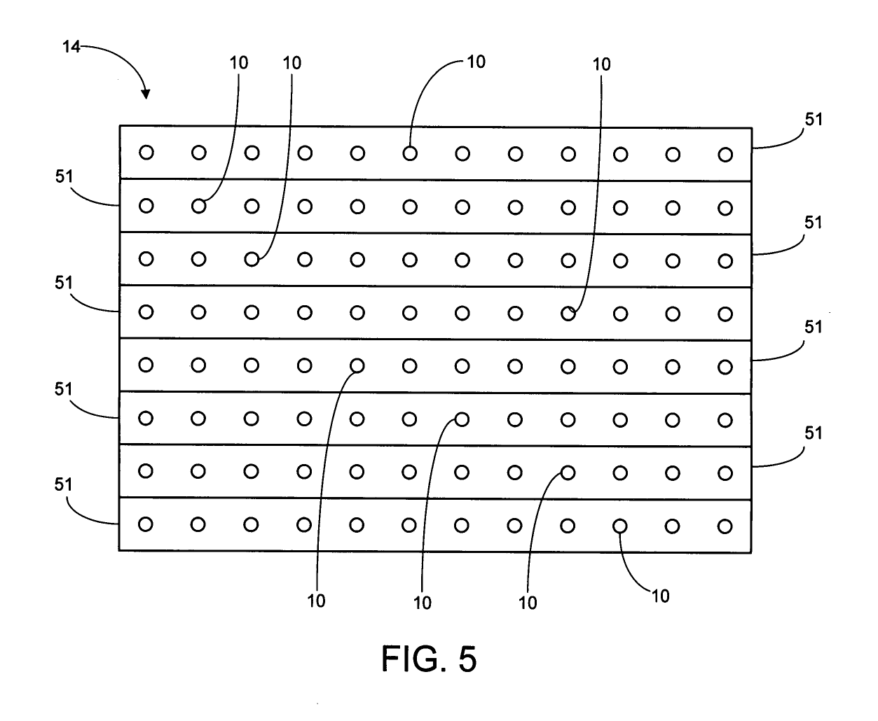

The array 14 of pegs 10 of the present display device can be implemented in a variety of ways. In one embodiment the array of pegs has a base plate that pegs extend from. In another embodiment, an interlocking strip arrangement is employed. FIG. 5 shows an exemplary front view of this latter embodiment of the array 14 of pegs 10 in which the array 14 is made up of a number of interlocking strips of pegs 51 which are joined together side-by-side. Each strip of pegs 51 includes a series of pegs 10 which are located on the top of the strip 51. As discussed below, the strip of pegs 51, the pegs 10, and the method by which the pegs 10 are attached to the strip of pegs 51 can each be implemented in a variety of ways.

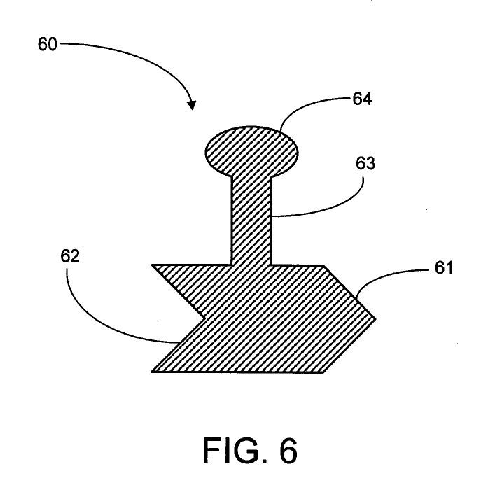

FIG. 6 shows an exemplary cross-section view of one embodiment of the strip of pegs 51 shown in FIG. 5, termed strip of pegs-A 60. Strip of pegs-A 60 has a unitary construction which includes one or more posts 63 whose proximal ends are permanently attached to the top of the strip of pegs-A 60, and caps 64 permanently attached to the distal ends of each of the posts 63. Furthermore, strip of pegs-A 60 includes a protruding feature 61 disposed onto one of its side edges and a matching detent feature 62 disposed onto the other of its side edges which serve to allow multiple strip of pegs-As 60 to be joined together side-by-side in a self-aligning, interlocking fashion.

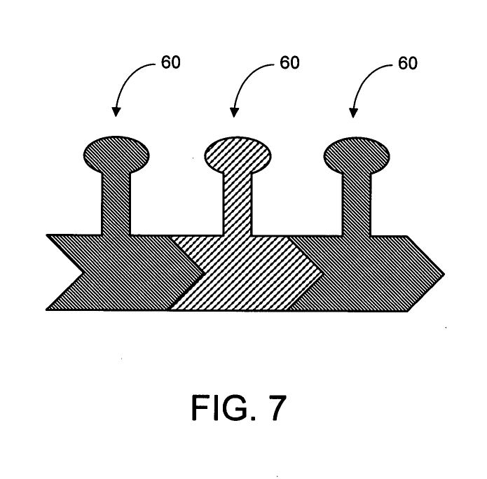

FIG. 7 shows an exemplary cross-section view of one embodiment of three strip of pegs-As 60 joined together side-by-side in self-aligning, interlocking fashion. A variety of array 14 sizes and related display module I sizes can be produced by constructing each strip of pegs-A 60 to a desired length and joining a desired quantity of strip of pegs-As 60 together.

It is noted that while the various foregoing peg configurations were described in connection to their implementation in the interlocking strip embodiment, they could also be implemented in the embodiment of the peg array employing a base plate.

As stated above, the present display device can be placed in any physical orientation and can be mounted for viewing in a variety of ways. By way of example but not limitation, the display module 1 can be placed along its rear side on a horizontal surface such as a table for vertical viewing from above. The display module 1 can also be placed along its rear side on a horizontal surface such as a ceiling for vertical viewing from below. The display module 1 can also be placed along one of its peripheral edges on a horizontal surface such as an easel, shelf or table for horizontal viewing. The display module 1 can also be hung from or fastened to vertical surface such as a wall or window for horizontal viewing.

While the present invention has been described in detail by specific reference to embodiments thereof, it is understood that variations and modifications thereof may be made without departing from the true spirit and scope of the present invention. For example, referring to FIGS. 1, 5, 6 and 7, in one embodiment of the present display device described above, the display module 1 has a rectangular shape, a certain quantity of EL wire connectors 8 are located on each of the peripheral edges of the display module 1, and the array 14 of pegs 10 is implemented via joining together self-aligning, interlocking strips of pegs 51/60 which have a unitary construction that includes the proximal end of posts 63 permanently attached to the top of each strip of pegs 51/60 and caps 64 permanently attached to the distal end of each post 63. Furthermore, the array 14 of pegs 10 is arranged in a rectangular grid with uniform spacing between all the pegs 10. All of these characteristics can be modified in the ways described below to create alternate implementations of the display device depending on the needs of a specific type of market or application that the display device is targeted towards, and the specific content of the information that may be displayed in said market or application.

In another embodiment of the display device, the display module can have a variety of other shapes, including a triangular shape, square shape, hexagonal shape, or circular shape, among others.

In yet another embodiment of the display device, the cross-sectional area of the post section of the pegs in the array of pegs can have a variety of shapes, including a triangular shape, square shape, hexagonal shape, or circular shape, among others.

In yet another embodiment of the display device, the cap portions of the pegs in the array of pegs can have a variety of shapes other than the modified spherical shape described previously. For example, the cap could have a substantially cubic shape, or pyramidal shape, or a disk shape, among others. In regard to the disk shaped embodiments, the disk could have a cylindrical, square, triangular, or any other appropriate cross-sectional area when viewed from above.

In yet another embodiment of the display device, the cap portions of the pegs in the array of pegs are eliminated and just the post is employed.

In yet another embodiment of the display device, EL wire connectors can be located on only a subset of the peripheral edges of the display module.

In yet another embodiment of the display device, the quantity of EL wire connectors can be varied and a different quantity of EL wire connectors can be located on each of the peripheral edges of the display module.

In yet another embodiment of the display device, EL wire connectors can be located anywhere within the array of pegs, and if desired, anywhere along the peripheral edges of the display module as well.

In yet another embodiment of the display device, the array of pegs can be arranged in a variety of other patterns which utilize a variety of other peg spacing manifestations including ones in which the spacing between pegs is varied.

In yet another embodiment of the display device, a brightness control dial 17 (shown in FIGS. 1, 3 and 4) can be added to the periphery of the display module 1 which would enable the user to adjust the brightness level of the light emitted by all the EL wires 9 in common, independent of the particular display mode that the display module 1 is operating in. Referring specifically to FIG. 4, the brightness control dial 17 is connected to the control module 41 via cable 46.

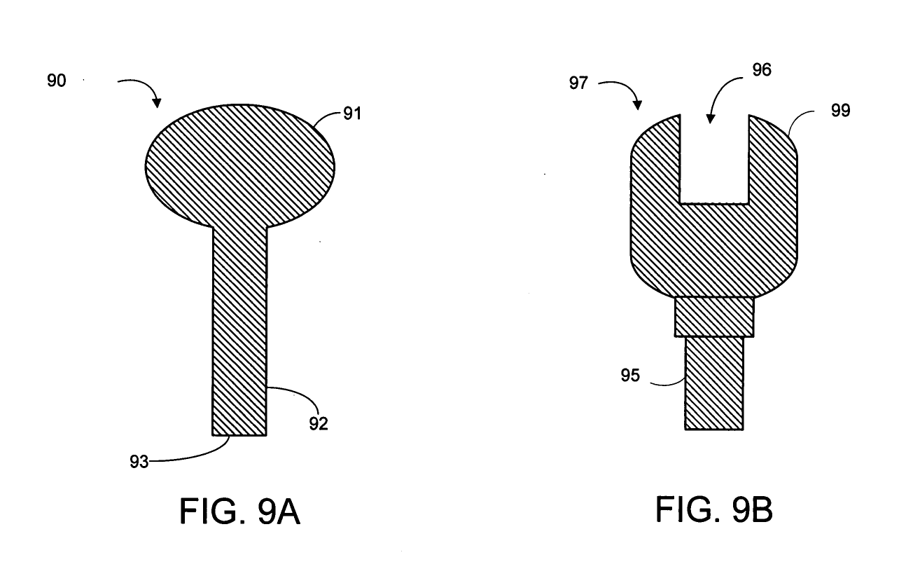

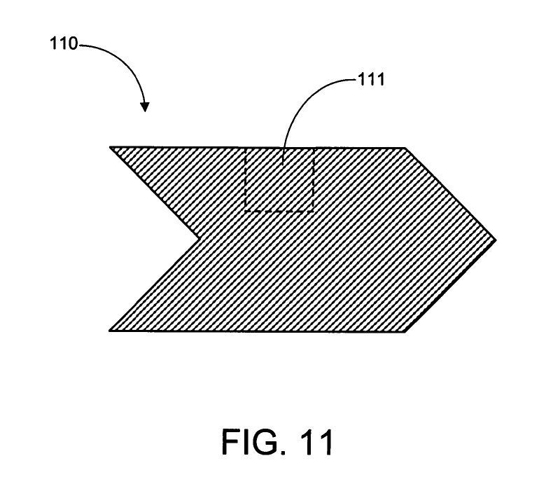

In yet another embodiment of the display device, strip of pegs 51 is implemented as shown in FIGS. 9A and 11. More particularly, FIG. 11 shows an exemplary cross-section view of another embodiment of strip of pegs 51, termed strip of pegs-B 110, which includes one or more holes 111 constructed into the top of the strip of pegs-B 110. FIG. 9A shows an exemplary cross section view of another embodiment of peg 10, termed peg-A 90. Peg-A 90 is a stand-alone part that has a unitary construction which includes a cap 91 permanently attached to the distal end of a post 92. The user can plug the proximal ends 93 of peg-As 90 into one or more holes 111, thus creating a customized peg layout pattern on the display device which they can subsequently easily reconfigure as desired.

In yet another embodiment of the display device, strip of pegs 51 is implemented as shown in FIGS. 9B and 11. More particularly, FIG. 11 shows an exemplary cross-section view of another embodiment of strip of pegs 51, termed strip of pegs-B 110, which includes one or more holes 111 constructed into the top of the strip of pegs-B 110. FIG. 9B shows an exemplary cross section view of another embodiment of peg 10, termed peg-B 97. Peg-B 97 is a stand-alone part that has a unitary construction which includes a cap 99 permanently attached to the distal end of a pin 95. The user inserts pin 95 completely into a hole 111 so that just cap 99 extends above the top of the strip of pegs-B 110. The pegs-B 97 can be placed so as to create a customized peg layout pattern on the display device which can subsequently be easily reconfigured as desired. However, in this embodiment, the cap 99 has a slot 96 at its distal end that an EL wire fits into and is held in place by, rather that the wire being routed around the aforementioned posts. The slots 96 of the peg caps 99 are oriented to facilitate the routing of the EL wire secured therein.

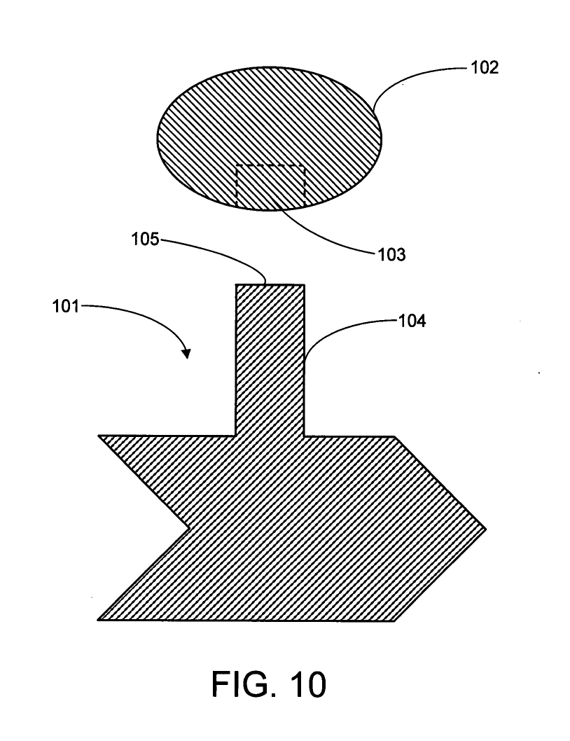

In yet another embodiment of the display device, strip of pegs 51 is implemented as shown in FIG. 10. More particularly, FIG. 10 shows an exemplary cross-section view of another embodiment of strip of pegs 51, termed strip of pegs-C 101 and cap-A 102. Strip of pegs-C 101 includes one or more posts 104 whose proximal ends are permanently attached to the top of the strip of pegs-C 101. Cap-A 102 is a stand-alone part which includes a hole 103 constructed into the bottom of the cap-A 102. The user can plug cap-As 102 onto one or more of the distal ends 105 of posts 104, thus creating a customized peg layout pattern on the display device which they can subsequently easily reconfigure as desired.

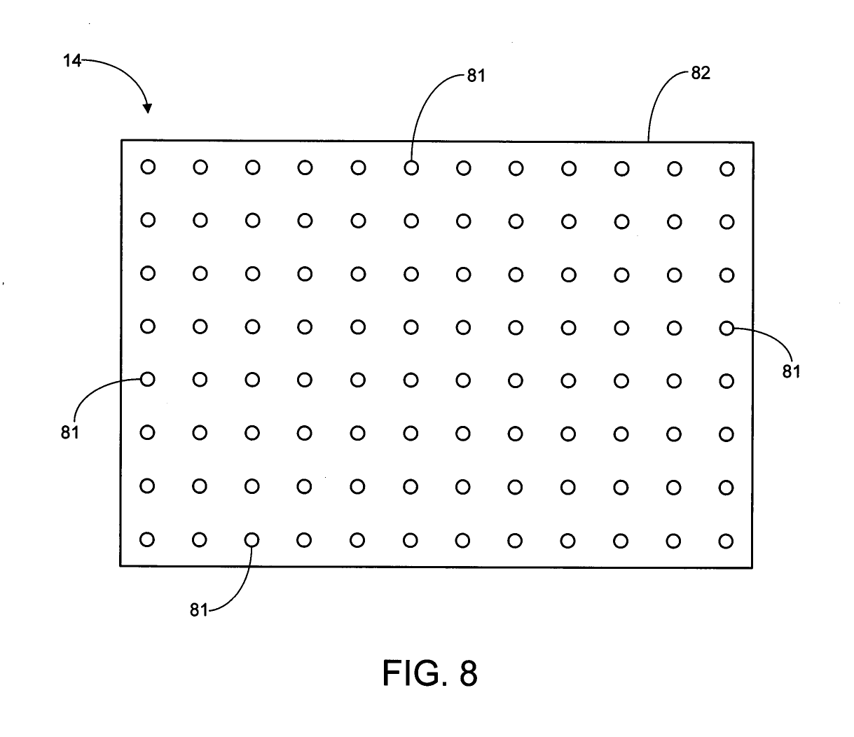

In yet another embodiment of the display device, the array 14 of pegs is implemented as shown in FIGS. 8 and 9. FIG. 8 shows an exemplary front view of another embodiment of the array 14 of pegs in which a plurality of holes 81 are constructed, in a prescribed pattern, into a single plate 82 which is constructed in the prescribed shape of the display device. The user can plug the proximal ends 93 of peg-As 90 into one or more of the holes 81, thus creating a customized peg layout pattern on the display device which they can subsequently easily reconfigure as desired.

In yet another embodiment of the display device, any of the peg configurations described previously that include a post also include a narrowed section near the proximal end of the post. This narrowed section allows the post to bend more easily so as to facilitate the insertion and routing of the EL wires. In addition, the narrowed section allows the post to deflect once the EL wire is installed so that the wire can bend around a post with a less extreme radius allowing for more curved appearance of the routed wire.

In yet another embodiment of the display device, the previously described border strips are eliminated. This embodiment could be employed in an arrangement of multiple electroluminescent wire display devices. For example, a wall, or a part thereof, could be covered with multiple display devices in an abutting pattern. Of course, a group of the display device embodiments having border strips could also be arranged in this fashion as well.

Referring to the embodiment of the present display device exemplified in FIG. 1 and discussed above, the display module 1 is shown with an exemplary layout of the various user controls and external signal input connectors. In additional alternate embodiments of the display device the specific locations and layout of each of these controls and connectors can be modified depending on the needs of a specific type of market or application the display device is targeted towards. By way of example but not limitation, the sensitivity control dial 6 and or brightness control dial 17 can be moved to a corner on the display module 1. Furthermore, the specific types of controls and connectors used on the display module 1 can also be modified to suit the specific needs of the market or application the display device is targeted towards. By way of example but not limitation, a rocker-type switch can be used in place of a slider-type switch for the display mode switch 5. By way of further example but not limitation, a slider-type control can be used in place of a dial-type control for the sensitivity control 6 and brightness control 17.

Referring again to the embodiment of the present display device exemplified in FIG. 1, a variety of exemplary display modes were discussed above. It should be noted that the display module 1 can be implemented with any particular combination of the aforementioned different display modes and related external signal input connectors. Hence, a variety of alternate embodiments of the display device are possible whereby the combination of different display modes and signal input connectors is selected to suit the specific needs of the market or application the display device is targeted towards.

It should be noted that any or all of the aforementioned alternate embodiments may be used in any combination desired to form additional hybrid embodiments. In addition, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Wherefore, what is claimed is:

1. A device for displaying a variety of types of user-configurable information, comprising:
one or more individual segments of illumable electroluminescent (EL) wire; and
a display module, comprising,
an array of pegs located within a viewable window on the front of the display module,
one or more EL wire connectors, wherein for each EL wire, a user connects the EL wire to one of the EL wire connectors, and then configures the EL wire into a desired geometric pattern by routing the EL wire through the array of pegs, wherein the geometric pattern is selected by the user based on the specific content of the information they want to display.

2. The device of claim 1, wherein the display module further comprises a control module, located inside the display module, wherein the control module supplies a separate, independently controlled electrical signal to each EL wire connector, and each EL wire connector in turn supplies the electrical signal to an EL wire connected to the connector causing the EL wire to emit light at a prescribed brightness level and in a prescribed color and timing pattern.

3. The device of claim 1, wherein the EL wire connectors are hidden underneath border strips which frame the peripheral edges of the display module.

4. The device of claim 3, wherein,
each border strip is independently hinged onto the display module by one or more hinges located along the coincident peripheral edge of said border strip and the display module, and
the user gains access to the EL wire connectors by lifting the inside edge of the corresponding border strip thereby rotating the border strip along the hinge(s) away from the array of pegs.

5. The device of claim 1, wherein the information displayed is reconfigurable, said reconfiguration comprising at least one of:
re-routing existing EL wires through the array of pegs;
moving an existing EL wire to a different, unused EL wire connector; and
connecting additional EL wires into unused EL wire connectors and routing them through the array of pegs.

6. The device of claim 2, wherein the control module further comprises:
a brightness level controller to control the brightness level of the light emitted by each EL wire; and
a timing pattern controller to control the timing pattern of the light emitted by each EL wire.

7. The device of claim 1, wherein a variety of user controls are located on the periphery of the display module, the user controls comprising at least one of:
a display mode actuator allowing the user to turn the display module on and off, and to select a particular operating display mode for the display module from a variety of possible operating display modes;
a test actuator, wherein, when the display mode actuator is set to an operating display mode other than off, and the user presses the test actuator, the operating display mode is temporarily overridden and all the EL wires continuously emit light until the user releases the test actuator, after which the display module returns to operating in the display mode set by the display mode actuator; and
a sensitivity control actuator allowing the user to adjust the sensitivity of the control module in particular display modes.

8. The device of claim 7, wherein the variety of possible operating display modes comprises at least one of:
a constant-on display mode in which all the EL wires emit light continuously at a prescribed brightness level;
a constant-flash display mode in which all the EL wires flash on and off in unison at a prescribed brightness level and duty cycle;
a random-flash display mode in which each EL wire flashes on and off randomly at a prescribed brightness level;
a microphone-sync display mode in which all the EL wires flash on and off in synchronization with changes in the frequency and/or amplitude of a microphone signal which is supplied to the display module by a conventional microphone; and
an audio-sync display mode in which all the EL wires flash on and off in synchronization with changes in the frequency and/or amplitude of an audio signal which is supplied to the display module by one of a variety of audio sources.

9. The device of claim 7, wherein the variety of user controls further comprises a brightness control actuator allowing the user to adjust the brightness level of the light emitted by the EL wires in common, independent of the particular operating display mode.

10. The device of claim 1, wherein the array of pegs is comprised of strips of pegs which are joined together side-by-side, wherein each strip of pegs comprises:
a protruding feature disposed onto one of its side edges; and
a matching detent feature disposed onto the other of its side edges, wherein the protruding feature and matching detent feature serve to allow the strips of pegs to be joined together side-by-side in a self-aligning, interlocking fashion.

11. The device of claim 10, wherein the size of the array of pegs is varied by varying the length of each strip of pegs and the quantity of strips of pegs that are joined together.

12. The device of claim 1, wherein the array of pegs has a unitary construction that further comprises:
a base plate;
one or more posts, each having a first cross-sectional area, which serve to channel the routing of the EL wires, wherein the proximal end of each post is permanently attached to the top of the base plate; and
one or more caps, each having a second cross-sectional area that is larger than the first cross-sectional area of the posts, wherein a cap is permanently attached to the distal end of each post, each cap serving to retain the EL wires routed adjacent to each post in place under the cap.

13. The device of claim 1, wherein the array of pegs further comprises:
a base plate;
one or more posts, each having a first cross-sectional area, which serve to channel the routing of the EL wires, wherein the proximal end of each post is permanently attached to the top of the base plate; and
one or more caps, each constructed as a separate part with a hole constructed into its bottom, and each having a second cross-sectional area that is larger than the first cross-sectional area of the posts, wherein the bottom of a cap is removably attached by the user to one or more of the distal ends of the posts in order to create a customized peg layout pattern.

14. The device of claim 1, wherein the array of pegs comprises:
a base plate into which a plurality of holes is constructed in a prescribed pattern; and
one or more pegs, each having a unitary construction, each peg comprising,
a post with a first cross-sectional area, and
a cap with a second cross-sectional area that is larger than the first cross-sectional area of the post, wherein,
the cap is permanently attached to the distal end of the post, and
the proximal end of one or more pegs is removably attached by the user into one or more holes in the base plate in order to create a customized peg layout pattern, each peg serving to channel the routing of the EL wires and retain the EL wires routed adjacent to the peg in place.

15. The device of claim 1, wherein the array of pegs comprises:
a base plate into which a plurality of holes is constructed in a prescribed pattern; and
one or more pegs, each having a unitary construction, each peg comprising,
a pin with a first cross-sectional area, and
a cap with a second cross-sectional area that is larger than the first cross-sectional area of the pin, wherein,
the cap is permanently attached to a proximal end of the pin and comprises a slot having a width such that said EL wire fits into and is secured in the slot, and
the pin of one or more pegs is removably inserted by the user into one or more holes in the plate in order to create a customized peg layout pattern, each peg serving to channel the routing of an EL wire and retain the EL wire routed through said slot of the peg cap.

16. The device of claim 1, wherein the array of pegs comprises:
a base plate;
one or more posts which serve to channel the routing of the EL wires, wherein each post extends from the base plate and comprises a section of narrowed cross-sectional area; and
one or more caps, each having a cross-sectional area that is larger than that of the posts, wherein a cap is permanently attached to the end of each post opposite the base plate, each cap serving to retain the EL wires routed adjacent to each post in place under the cap, and wherein the section of narrowed cross-section of each post allows the post to bend so as to facilitate routing of the EL wires.

17. The device of claim 1, wherein physical characteristics of the display module are varied in order to tailor the display module to the needs of a specific market or application, said physical characteristics comprising at least one of:
the shape of the display module;
the quantity and placement of the EL wire connectors located on each of the peripheral edges of the display module; and
the physical placement of, and spacing between each of the pegs.

18. The device of claim 1, wherein the characteristics of each EL wire are selected by the user based on the specific content of the information they want to display, said characteristics comprising at least one of:
the length of each EL wire;
the color of each EL wire; and
the diameter of each EL wire, wherein the maximum allowable diameter is limited by the spacing between the pegs.

19. A display device, comprising:
one or more individual segments of illumable electroluminescent (EL) wire; and
an array of pegs to retain the segments of EL wire in a variety of user-configured geometric patterns.

20. A device for displaying user-configurable information, comprising:
one or more individual segments of electroluminescent (EL) wire;
a means for channeling a user's routing of each segment of EL wire into a desired geometric pattern;
a means for retaining the routed geometric pattern of each EL wire in place; and
a means for independently illuminating each segment of EL wire.
